(19) United States
(12) Patent Application Publication
(10) Pub. No.: US 2018/0275928 A1
(43) Pub. Date: Sep. 27, 2018

(54) IMAGE FORMING APPARATUS AND INFORMATION PROCESSING SYSTEM

(71) Applicant: FUJI XEROX CO., LTD., Tokyo (JP)

(72) Inventors: Yoshihiro SEKINE, Kanagawa (JP); Ryuichi ISHIZUKA, Kanagawa (JP); Keita SAKAKURA, Kanagawa (JP); Takeshi FURUYA, Kanagawa (JP); Hiroshi MIKURIYA, Kanagawa (JP); Kenji KUROISHI, Kanagawa (JP); Eiji NISHI, Kanagawa (JP); Hiroshi HONDA, Kanagawa (JP)

(73) Assignee: FUJI XEROX CO., LTD., Tokyo (JP)

(21) Appl. No.: 15/893,764

(22) Filed: Feb. 12, 2018

(30) Foreign Application Priority Data
Mar. 24, 2017 (JP) 2017-058749

(51) Int. Cl. G06F 3/12

(52) U.S. Cl. CPC G06F 3/1225; G06F 3/129

(57) ABSTRACT

An image forming apparatus includes an image forming section that forms an image on a recording material; an acquiring section that acquires information from plural devices that are disposed in a room and acquire information on the room; a processing section that processes the information acquired by the acquiring section, and generates information that is used by an external device; and an initializing section that initializes the plural devices disposed in the room.

### CROSS-REFERENCE TO RELATED APPLICATIONS

This application is based on and claims priority under 35 USC 119 from Japanese Patent Application No. 2017-058749 filed Mar. 24, 2017.

### BACKGROUND

The present invention relates to an image forming apparatus and an information processing system.

### SUMMARY

According to an aspect of the invention, there is provided an image forming apparatus includes an image forming section that forms an image on a recording material; an acquiring section that acquires information from plural devices that are disposed in a room and acquire information on the room; a processing section that processes the information acquired by the acquiring section, and generates information that is used by an external device; and an initializing section that initializes the plural devices disposed in the room.

### BRIEF DESCRIPTION OF THE DRAWINGS

An exemplary embodiment of the present invention will be described in detail based on the following figures, wherein:

FIG. 1 illustrates a general configuration of an office environment management system;

FIG. 2 illustrates a configuration of hardware of an image forming apparatus;

FIG. 3 illustrates respective functional units included in each image forming apparatus and implemented by a central processing unit (CPU) and other parts of the image forming apparatus;

FIG. 4 illustrates a configuration of hardware of a service providing server;

FIG. 5 illustrates a flow of processing during initialization of a sensor;

FIG. 6 illustrates a flow of processing during initialization of an actuator;

FIG. 7 illustrates a flow of processing when an update program is transmitted to the sensor and the sensor is initialized; and

FIG. 8 illustrates a flow of processing when an update program is transmitted to the actuator and the actuator is initialized.

### DETAILED DESCRIPTION

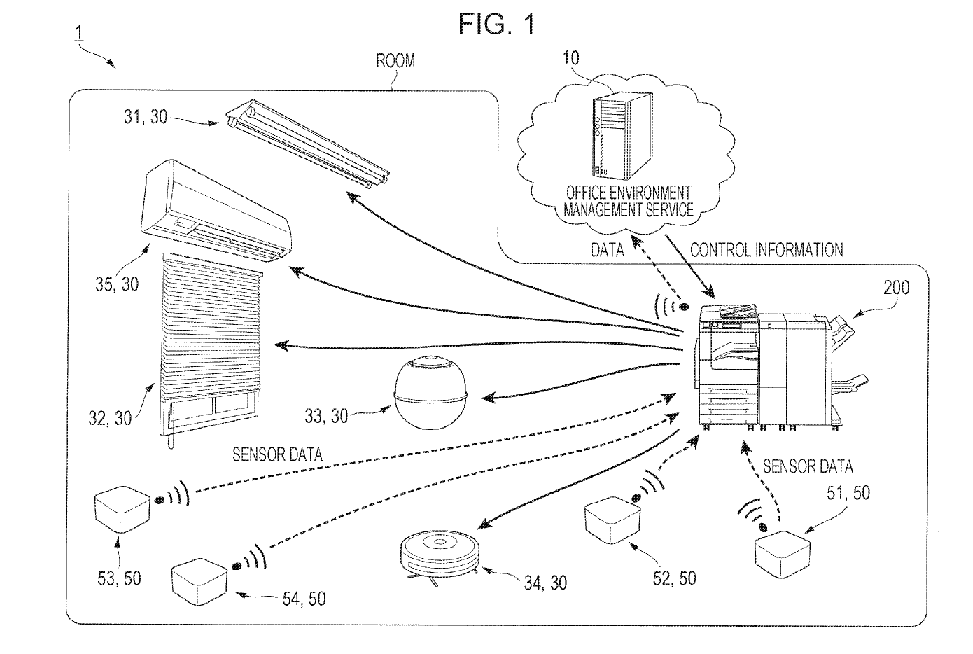

An exemplary embodiment of the present invention is described below with reference to the accompanying drawings. FIG. 1 illustrates a general configuration of an office environment management system 1. The office environment management system 1 serving as an example of an information processing system is provided with a service providing server 10 serving as an example of an external device in a cloud. While FIG. 1 illustrates a single service providing server 10, plural service providing serves 10 are disposed by a number corresponding to the number of services to be provided in a room. In other words, in this exemplary embodiment, a case in which a service that manages the environment of an office is provided for a user in a room is exemplarily described. When an additional service is provided, an additional service providing server 10 corresponding to the additional service is arranged.

Further, the office environment management system 1 according to this exemplary embodiment is provided with an image forming apparatus 200 in the room, as an example of an information processing apparatus. The image forming apparatus 200 is connected to the service providing server 10 and functions as a gateway or an edge server. The image forming apparatus 200 is disposed in a room (office) where a user works. The image forming apparatus 200 has a function of forming an image on a recording material such as paper, FAX function, and scanner function. The office environment management system 1 is further provided with a sensor 50 serving as an example of a device, and an actuator 30. Plural sensors 50 and plural actuators 30 are disposed in the room.

Each actuator 30 is connected with the service providing server 10 via the image forming apparatus 200 and a communication line such as an Internet line, and is controlled by the service providing server 10. Each sensor 50 is disposed in the room and acquires various information on the room. The sensor 50 outputs the acquired information to the image forming apparatus 200. Then, the image forming apparatus 200 outputs the information to the service providing server 10. The service providing server 10 controls the actuator 30 on the basis of the information transmitted from the image forming apparatus 200 (the information acquired by the sensor 50).

The actuator 30 communicates with the image forming apparatus 200, and receives a control signal from the image forming apparatus 200 (a control signal transmitted from the service providing server 10 via the image forming apparatus 200). In this exemplary embodiment, an illumination device 31, a blind (window shade) device 32, a humidifier 33, a cleaner 34, and an air conditioner 35 are provided as examples of the actuator 30.

The illumination device 31 includes a light source, and turns on and off the light source in accordance with a control signal from the service providing server 10. The blind device 32 has a blind (window shade) and a driving mechanism that changes the state of the blind, and changes the state of the blind in accordance with a control signal from the service providing server 10. Hence, the amount of external light which enters the room is changed.

The humidifier 33 has a mechanism that vaporizes water, and humidifies the room in accordance with a control signal from the service providing server 10. The cleaner 34 has a suction mechanism that sucks dust in the office, and moves in the room and collects the dust in the room in accordance with a control signal from the service providing server 10. The air conditioner 35 includes a heat source etc., and controls air conditioning in the office in accordance with a control signal from the service providing server 10.

Also, in this exemplary embodiment, a temperature sensor 51 that measures the temperature, a humidity sensor 52 that measures the humidity, an illuminance sensor 53 that measures the illuminance, and a human-presence sensor 54 that is, for example, an infrared sensor and detects presence of a human in the room are provided as examples of the sensor 50. Each sensor 50 transmits acquired information to the image forming apparatus 200 by using wireless communication or wired communication (by communicating with the image forming apparatus 200). The image forming apparatus 200 transmits information (sensor data) from the sensor 50 to the service providing server 10. In the office environment management system 1, the service providing server 10 transmits control information that is used for controlling each of the actuators 30, to the image forming apparatus 200. The image forming apparatus 200 transmits the control information to the corresponding actuator 30.

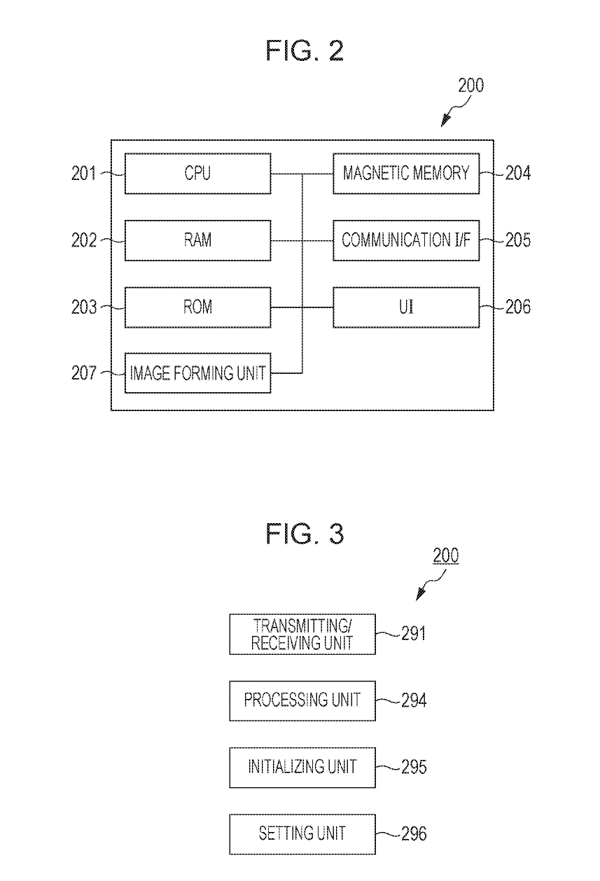

FIG. 2 illustrates a configuration of hardware of the image forming apparatus 200. As illustrated in FIG. 2, the image forming apparatus 200 includes a central processing unit (CPU) 201, a random access memory (RAM) 202, a read only memory (ROM) 203, and a magnetic memory 204. The image forming apparatus 200 also includes a communication interface (communication I/F) 205 for communication with an external device.

The image forming apparatus 200 further includes a user interface (UI) 206 and an image forming unit 207. The UI 206 is, for example, a touch-panel display, receives information to be displayed, and displays (makes notification about) this information to the user. The UI 206 receives an operation from the user. The image forming unit 207 serving as an example of an image forming section uses an electrophotographic system or an inkjet head system, and forms an image on a sheet of paper, which is an example of a recording material.

The ROM 203 and the magnetic memory 204 store programs that are executed by the CPU 201. The CPU 201 reads a program stored in the ROM 203 or the magnetic memory 204, and executes the program while using the RAM 202 as a work area. The CPU 201 executes the programs stored in the ROM 203 and the magnetic memory 204, and hence respective functional units (described later) illustrated in FIG. 3 are implemented.

The program that is executed by the CPU 201 may be provided to the image forming apparatus 200, in a state in which the program is stored in a computer readable storage medium, such as a magnetic storage medium (magnetic tape, magnetic disk, etc.), an optical storage medium (optical disc, etc.), a magneto-optical storage medium, or a semiconductor memory. Alternatively, the program that is executed by the CPU 201 may be downloaded in the image forming apparatus 200 by using a communication measure such as the Internet.

FIG. 3 illustrates respective functional units that are included in the image forming apparatus 200 and implemented by the CPU 201 and other parts of the image forming apparatus 200. The image forming apparatus 200 includes a transmitting/receiving unit 291 serving as an example of an acquiring section and a transmitting section. The transmitting/receiving unit 291 uses the CPU 201 and the communication I/F 205 of the image forming apparatus 200, and transmits and receives information.

To be specific, for example, the transmitting/receiving unit 291 receives and acquires sensor data that is information from the sensor 50 disposed in the room. The transmitting/receiving unit 291 transmits information to the actuator 30. The transmitting/receiving unit 291 receives information from the service providing server 10 and transmits information to the service providing server 10.

The image forming apparatus 200 includes a processing unit 294 serving as an example of a processing section. The processing unit 294 performs predetermined processing (for example, previous processing such as noise reduction and/or event detection) on the sensor data acquired by the transmitting/receiving unit 291, and generates information that is used by the service providing server 10 as an example of an external device.

In other words, the processing unit 294 processes the sensor data acquired by the transmitting/receiving unit 291, and generates information that is output to the service providing server 10. In this exemplary embodiment, the sensor data processed by the processing unit 294 is transmitted to the service providing server 10. The service providing server 10 controls the actuator 30 disposed in the room, on the basis of the sensor data.

The image forming apparatus 200 further includes an initializing unit 295 serving as an example of an initializing section, and a setting unit 296 serving as an example of a setting section. The initializing unit 295 initializes the actuator 30 and the sensor 50 disposed in the room. The setting unit 296 performs setting processing on the actuator 30 and the sensor 50.

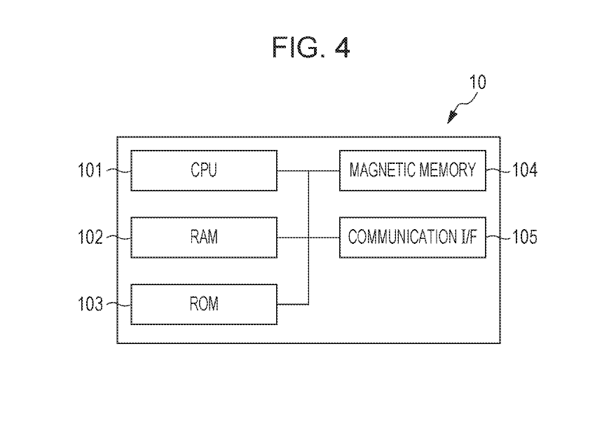

FIG. 4 illustrates a configuration of hardware of the service providing server 10. As illustrated in FIG. 4, the service providing server 10 includes a central processing unit (CPU) 101, a random access memory (RAM) 102, a read only memory (ROM) 103, and a magnetic memory 104. The service providing server 10 also includes a communication interface (communication I/F) 105 for communication with an external device.

### Initialization etc. of In-Room Device

In this exemplary embodiment, the initializing unit 295 of the image forming apparatus 200 disposed in the room periodically or non-periodically initializes the actuator 30 and the sensor 50 (hereinafter, these devices are referred to as “in-room device” if necessary) disposed in the room and performs cleaning. The initializing unit 295 also periodically or non-periodically carries out a virus check for the in-room device.

In this case, the initialization represents that the power of the in-room device is turned off and turned on again, the state of the in-room device is restored to the factory-default state, the set value set for the in-room device is restored to the factory-default value, and software stored in the in-room device is updated. In other words, the initialization represents causing the state of the in-room device to approach the factory-default state as compared with the state before the initialization processing.

The initializing unit 295 and the setting unit 296 perform the processing such as the initialization on the in-room device, and then perform setting processing of setting information. To be more specific, the initializing unit 295 and the setting unit 296 hold information (setting information) stored in the in-room device before the initializing unit 295 and the setting unit 296 perform the processing such as the initialization on the in-room device. After the initializing unit 295 and the setting unit 296 end the initialization etc. of the in-room device, the initializing unit 295 and the setting unit 296 transmit the held information to the in-room device, and perform the setting processing of the setting information. Further, in this exemplary embodiment, the setting unit 296 updates (sets) a password of each in-room device.

Also, the initializing unit 295 and the setting unit 296 perform the processing such as the initialization sequentially on each in-room device. In other words, when plural in-room devices are present in the room, the initializing unit 295 and the setting unit 296 perform the initialization etc. not simultaneously on all the in-room devices, but perform the initialization etc. sequentially on the in-room devices at different times.

In this exemplary embodiment, the initialization etc. is performed sequentially so that a former in-room device on which the initialization etc. is performed first and a later in-room device on which the initialization etc. is performed subsequently to the former in-room device have a predetermined positional relationship. To be specific, the initialization etc. is performed sequentially not on in-room devices having a mutually close relationship in terms of distance, but the initialization etc. is performed sequentially on in-room devices having a mutually separated relationship. To be more specific, the initialization etc. is sequentially performed so that the distance between the former in-room device on which the initialization etc. is performed first and the later in-room device on which the initialization etc. is performed subsequently to the former in-room device is larger than a predetermined distance. Alternatively, in this exemplary embodiment, the initialization etc. is performed randomly on plural in-room devices.

This may suppress occurrence of a phenomenon in which the condition of part of the room is not recognized at all. For example, if the processing such as the initialization is performed in the order of arrangement of in-room devices, the in-room devices on which the initialization etc. is performed may be concentrated in a specific portion of the room, and the condition of part of the room may not be recognized. In contrast, if the initialization etc. is performed sequentially on the mutually separated in-room devices, the occurrence of the phenomenon in which the condition of part of the room is not recognized may be suppressed.

If the initialization etc. is performed sequentially on the mutually separated in-room devices, the image forming apparatus 200 needs to previously recognize the position of each in-room devices. In this case, for example, the image forming apparatus 200 recognizes the position of each in-room device on the basis of the position information on the in-room device previously stored in the image forming apparatus 200.

To be more specific, in this case, for example, a manager previously registers position information on in-room devices disposed in the room, in the image forming apparatus 200. The initializing unit 295 and the setting unit 296 of the image forming apparatus 200 recognize the position of each in-room device on the basis of the registered position information. Alternatively, the position information may be recognized such that the in-room devices each have a function of acquiring position information by using global positioning system (GPS) etc. and the position of each in-room device may be recognized on the basis of the position information acquired by the in-room device.

Also, in this exemplary embodiment, the initializing unit 295 carries out a virus check for each in-room device by using a virus check program, and if the initializing unit 295 detects a virus, the initializing unit 295 initializes the in-room device from which the virus is detected. In this exemplary embodiment, the influence of the virus is suppressed by initializing the in-room device instead of using antivirus software or isolating the in-room device recognized as being infected with the virus.

The initializing unit 295 of the image forming apparatus 200 initializes an in-room device when the in-room device unstably operates, when the in-room device makes an access to a device that is not managed, and when the in-room device makes communication by using a protocol that is not managed, without limiting to the timing when a virus is detected.

In this exemplary embodiment, when the initializing unit 295 and the setting unit 296 perform the processing such as the initialization, the initializing unit 295 and the setting unit 296 receive the setting information set in the in-room device on which the initialization etc. is to be performed from the in-room device and hold the setting information, before the processing such as the initialization as described above. Then, the initializing unit 295 and the setting unit 296 transmit (set) the held setting information to (in) the in-room device on which the initialization etc. has been performed, after the processing such as the initialization. Hence, the in-room device operates under the same condition as the condition before the initialization.

Alternatively, the initializing unit 295 of the image forming apparatus 200 may perform the initialization by reinstalling software in the in-room device. The initializing unit 295 does not have to autonomously perform the initialization, and the initializing unit 295 may perform the initialization in response to an instruction from the user. When software is installed in (transmitted to) the in-room device from the image forming apparatus 200 (when update program etc. is transmitted), the software may be transmitted at once, or for software with a large volume, the software may be divided into multiple sections and transmitted.

When the versions of software stored in the respective in-room devices are different from one another, the setting unit 296 of the image forming apparatus 200 may transmit software to portions of the in-room devices to match the versions. In other words, the setting unit 296 may perform setting of matching the versions of the software stored in the respective in-room devices. To be more specific, when the versions of software stored in respective in-room devices of the same model (type) are different from one another, software may be transmitted to portions of the in-room devices and processing of matching the versions of the software may be performed.

If the versions of software are the same, the quality of service to be provided in the room is stably held as compared with the case where the versions of the software are different from one another. For the manager, if the versions of software are the same, the manager may manage the version of the software, the update of the software, and so forth, are managed with ease. Further, if the versions of software are the same, the in-room devices are controlled with ease and formats of notifications from the in-room devices become uniform as compared with the case where the versions of the software are different from one another.

Alternatively, the setting unit 296 of the image forming apparatus 200 may acquire version information on software of an in-room device that is newly disposed in the room, if the version of the software is old, transmit software of a new version (update program) to the in-room device, and cause the software to be installed. Accordingly, security of the in-room device that is newly installed is improved.

In many cases, the sensor 50 may have an insufficient memory and a low-performance CPU because of the cost etc. Also, in many cases, the sensor 50 may not have an indication function. In this case, the sensor 50 may not provide a necessary measure for security. In this case, even if the sensor 50 is infected with malware etc., it is difficult to detect and eliminate the malware.

To be specific, with such a sensor 50, it is difficult to install antivirus software and continuously update a pattern file. Hence, it is difficult to detect and eliminate malware. The sensor 50 may not have an indication function in many cases, and hence even if the sensor 50 detects an abnormality, the sensor 50 may not indicate this abnormality by itself.

If the actuator 30 or the sensor 50 is infected with malware, a malfunction, such as stealing of information, posing of data, or erroneous operation of the actuator 30, may occur. To suppress occurrence of such a malfunction, it is necessary to perform setting for security on respective in-room devices. However, performing the setting in all in-room devices without exception is troublesome work.

Also, in addition to the setting for security, periodical update of password, and update of software are also troublesome work if these are performed every in-room device. In contrast, in this exemplary embodiment, the image forming apparatus 200 disposed in the room performs the initialization etc. on in-room devices under management of the image forming apparatus 200 itself instead of the manager. Accordingly, the security of the entire room is improved while the burden of the manager is decreased.

The security may be improved, for example, by each of the in-room devices repeating the initialization etc. In this case, for example, information from the sensor 50 is required; however, the sensor 50 may autonomously start the initialization and information from the sensor 50 may be stopped. Also in this case, the image forming apparatus 200 may erroneously judge presence of an abnormality in an in-room device because of the sudden initialization. Further in this case, if an in-room device is infected with malware, the infection may invalidate the program for the initialization (initialization that is performed by the in-room device itself).

In contrast, in this exemplary embodiment, the image forming apparatus 200 performs the initialization etc. on an in-room device under the management of the image forming apparatus 200 itself. Accordingly, the above-described malfunction caused by that the in-room device itself performs the initialization etc. less likely occurs.

### Setting of Password

The setting unit 296 of the image forming apparatus 200 may periodically automatically generate passwords set for respective in-room devices, and may set the generated passwords in the respective in-room devices. In other words, the image forming apparatus 200 may manage the passwords. Accordingly, the burden of the manager who manages the passwords is reduced. The passwords set by the image forming apparatus 200 are notified to the manager by e-mail or another method, and/or registered in the image forming apparatus 200 to allow the manager to reference the passwords by using the UI 206 (see FIG. 2).

### Handling of Data During Initialization or Setting Processing

When the initialization of an in-room device or the setting of the in-room device is started, the in-room device temporarily stops outputting information, and output of information to the service providing server 10 may be stopped (output of information may be temporarily intermitted). To prevent this, for an in-room device on which the initialization or setting processing is performed and whose output of information is intermitted, the transmitting/receiving unit 291 according to this exemplary embodiment transmits information alternative to the information from the in-room device, to the service providing server 10.

To be specific, for the in-room device on which the initialization or setting processing is performed and whose output of information is intermitted, the transmitting/receiving unit 291 provides information output from the in-room device before the initialization or setting processing is started, to the service providing server 10. To be more specific, the transmitting/receiving unit 291 holds information which has been output from in-room devices for a predetermined period, and for the in-room device whose output of information is intermitted, the transmitting/receiving unit 291 transmits the information held therein to the service providing server 10.

There may be another processing in which, for the in-room device on which the initialization or setting processing is performed and whose output of information is intermitted, the transmitting/receiving unit 291 transmits information output from another in-room device having a predetermined positional relationship with respect to that in-room device, to the service providing server 10. To be specific, for the in-room device on which the initialization or setting processing is performed and whose output of information is intermitted, the transmitting/receiving unit 291 transmits information output from another in-room device of the same model (the same type) located near that in-room device, to the service providing server 10. To be more specific, for the in-room device on which the initialization or setting processing is performed and whose output of information is intermitted, the transmitting/receiving unit 291 transmits information output from another in-room device of the same model located within a predetermined distance from that in-room device, to the service providing server 10.

### Handling of Actuator

When the initializing unit 295 or the setting unit 296 of the image forming apparatus 200 performs the initialization or setting processing on the actuator 30, the initializing unit 295 or the setting unit 296 stops the actuator 30 when the processing is performed (before the processing is performed).

### Modifications

The above-described initialization processing and setting processing do not have to be automatically performed by the image forming apparatus 200, and may be performed in response to an instruction from the user to the image forming apparatus 200. The above-described initialization processing and setting information may be performed in response to an instruction from the service providing server 10 to the image forming apparatus 200.

### Flow of Processing

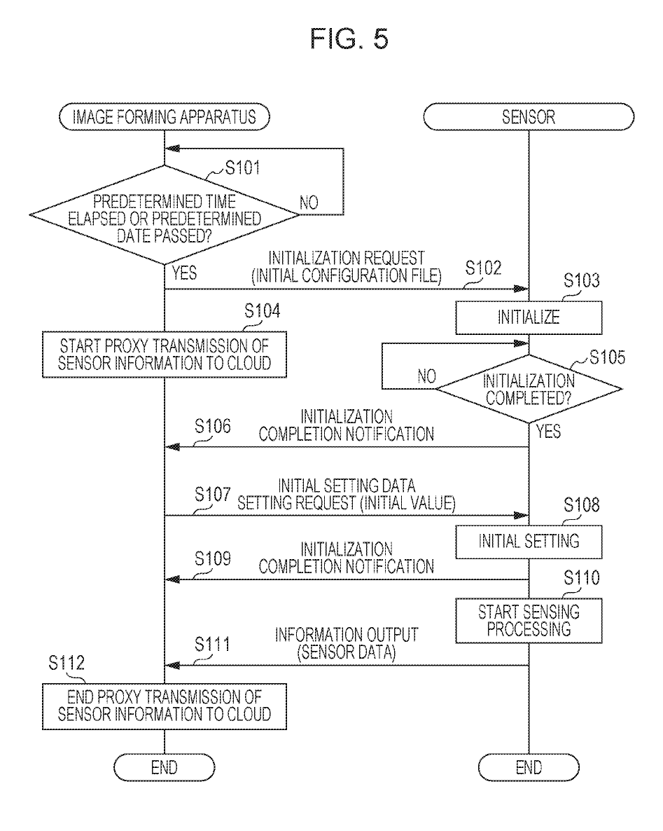

FIGS. 5 to 8 each illustrate example flows of processing that is performed by the image forming apparatus 200 and an in-room device. FIG. 5 illustrates a flow of processing during initialization of the sensor 50. In the processing illustrated in FIG. 5, the initializing unit 295 of the image forming apparatus 200 determines whether or not a predetermined time has elapsed, or whether or not a predetermined date has passed (step 101).

In other words, initialization is performed every predetermined time in this exemplary embodiment. In step 101, it is determined whether or not a predetermined time has elapsed since previous initialization. In step 101, if it is determined that the predetermined time has elapsed, the initializing unit 295 makes a request for initialization to the sensor 50 in the room (step 102). In this exemplary embodiment, the request for initialization is sequentially given to the respective in-room devices.

Accordingly, the sensor 50 is initialized (step 103). When the initialization processing on the sensor 50 is started, the sensor 50 no longer outputs information. Hence, in this processing example, the transmitting/receiving unit 291 of the image forming apparatus 200 transmits information output from the sensor 50 before the initialization processing is started, to the service providing server 10 (step 104). In other words, the transmitting/receiving unit 291 performs proxy transmission of information (sensor data) from the sensor 50.

After the initialization processing on the sensor 50 in step 103 is started (after the predetermined time has elapsed since the start of the initialization processing), the sensor 50 determines whether nor not the initialization processing has been completed (step 105). Then, if the sensor 50 determines the completion of the initialization processing, the sensor 50 transmits an initialization completion notification to the image forming apparatus 200 (step 106).

Then, in this processing, when the image forming apparatus 200 receives the initialization completion notification, the setting unit 296 makes a setting request for initial setting data to the sensor 50 (step 107). In other words, the setting unit 296 transmits a set value set by the sensor 50 before the initialization is performed (set value set by the sensor 50 and held by the setting unit 296 before the initialization is performed) to the sensor 50, and causes the sensor 50 to perform the setting processing of the set value.

Then, the sensor 50 receives the set value, and sets the set value on the sensor 50 itself (initial setting) (step 108). Then, the sensor 50 transmits an initialization completion notification indicative of the completion of the initialization to the image forming apparatus 200 (step 109). Then, the sensor 50 starts an operation (starts sensing) (step 110), and the sensor 50 outputs information to the image forming apparatus 200 (step 111). Then, the image forming apparatus 200 ends the proxy transmission started in step 104 (step 112).

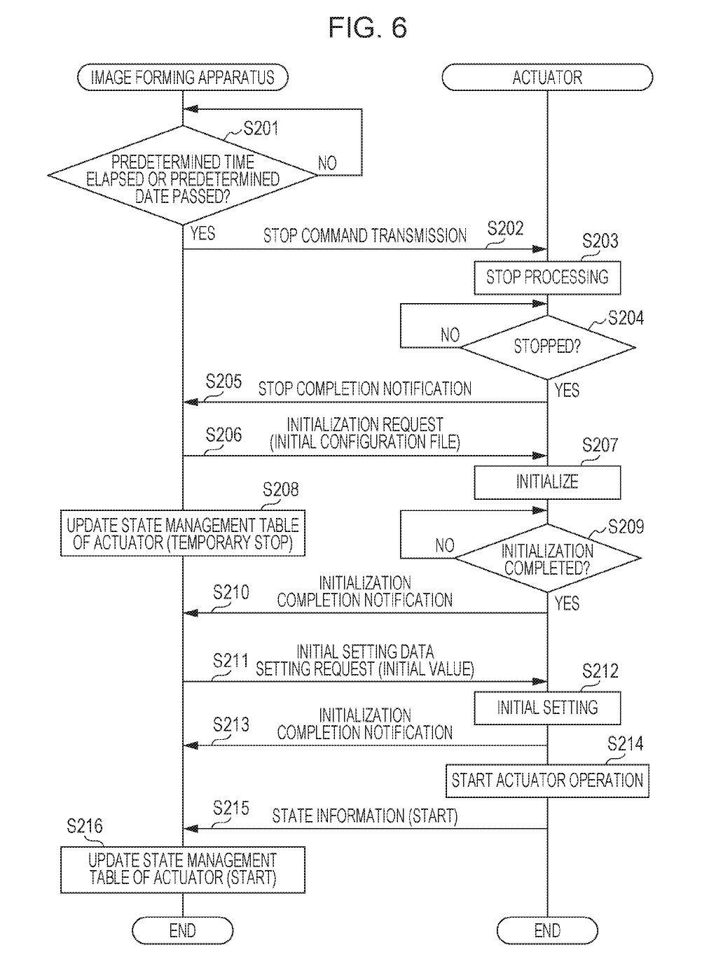

FIG. 6 illustrates a flow of processing during initialization of the actuator 30. In the processing illustrated in FIG. 6, like the above-described flow, the initializing unit 295 of the image forming apparatus 200 determines whether or not a predetermined time has elapsed, or whether or not a predetermined date has passed (step 201). In other words, the initializing unit 295 determines whether or not a predetermined time has elapsed since previous initialization. In step 201, if the initializing unit 295 determines that the predetermined time has elapsed, the initializing unit 295 transmits a stop command to the actuator 30 (step 202).

Then, the actuator 30 performs stop processing of stopping the operation of the actuator 30 itself (step 203). Then, after the actuator 30 starts the stop processing in step 203 (after a predetermined time has elapsed since the start of the stop processing), the actuator 30 determines whether or not the stop processing has been completed (step 204). If the actuator 30 determines the completion of the stop processing, the actuator 30 transmits a stop completion notification to the image forming apparatus 200 (step 205).

Then, in this processing, the initializing unit 295 of the image forming apparatus 200 makes a request for initialization to the actuator 30 that has performed the stop processing (step 206). The actuator 30 performs an initialization operation in response to the request (step 207). Also, in this processing, the image forming apparatus 200 updates the state management table indicative of the state of the in-room device (step 208), and registers that the actuator 30 is in a temporary stop state, in the state management table.

Then, the actuator 30 determines whether or not the initialization processing has been completed (step 209). If the actuator 30 determines the completion of the initialization, the actuator 30 transmits an initialization completion notification to the image forming apparatus 200 (step 210). When the image forming apparatus 200 receives the initialization completion notification, the setting unit 296 makes a setting request for initial setting data to the actuator 30 similarly to step 107 in FIG. 5 (step 211). In other words, the setting unit 296 transmits the set value set by the actuator 30 (set value held by the setting unit 296) before the initialization is performed to the actuator 30, and causes the actuator 30 to perform setting processing of the set value.

Then, the actuator 30 receives the set value, and sets the set value in the actuator 30 itself (initial setting) (step 212). Then, the actuator 30 transmits an initialization completion notification indicative of the completion of the initialization to the image forming apparatus 200 (step 213). Then, the actuator 30 starts an operation (step 214), and outputs information from the actuator 30 (state information indicative of the state of the actuator 30) to the image forming apparatus 200 (step 215). Then, in the image forming apparatus 200, the state management table is updated (step 216), and the start (re-start) of the operation of the actuator 30 is registered in the state management table.

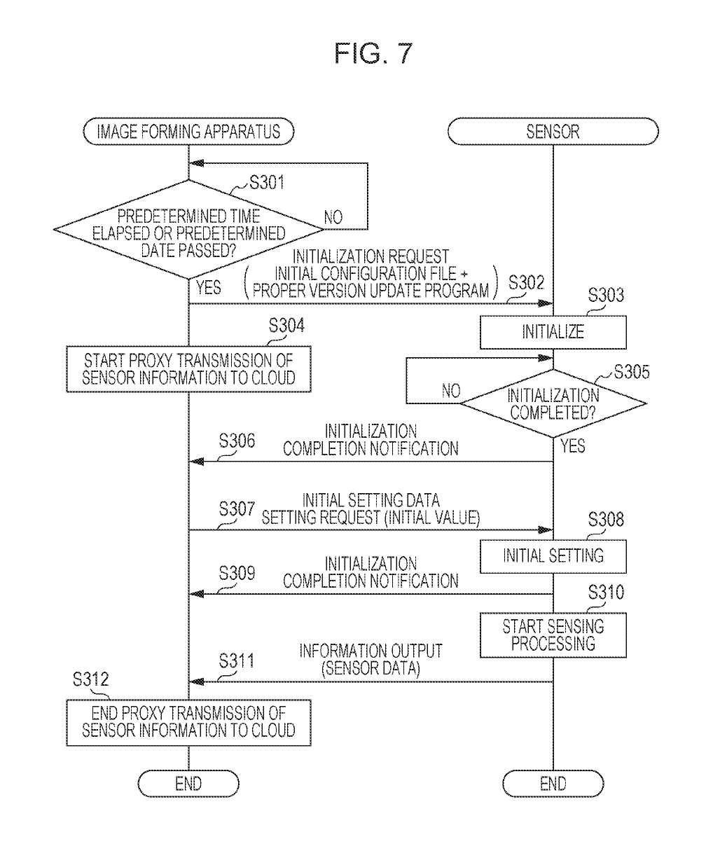

FIG. 7 illustrates a flow of processing when an update program is transmitted to the sensor 50 and the sensor 50 is initialized. In the processing, like the above-described flow, the initializing unit 295 determines whether or not a predetermined time has elapsed, or whether or not a predetermined date has passed (step 301). In other words, the initializing unit 295 determines whether or not a predetermined time has elapsed since previous initialization.

In step 301, if it is determined that the predetermined time has elapsed, the initializing unit 295 makes a request for initialization to the sensor 50 in the room (step 302). The initializing unit 295 makes a request for initialization sequentially to the respective in-room devices. In the request for initialization, the initializing unit 295 transmits an update program (program for latest version, or program with countermeasure for weakness) in addition to the information indicative of the request for initialization, to the sensor 50.

In response to the request, the sensor 50 performs initialization processing (step 303). To be specific, the sensor 50 installs the transmitted update program in the sensor 50 itself, and hence, the sensor 50 is initialized. Then the processing from step 304 to step 312 is performed. The processing from step 304 to step 312 is similar to the processing from step 104 to step 112 described above, and therefore the description is omitted here.

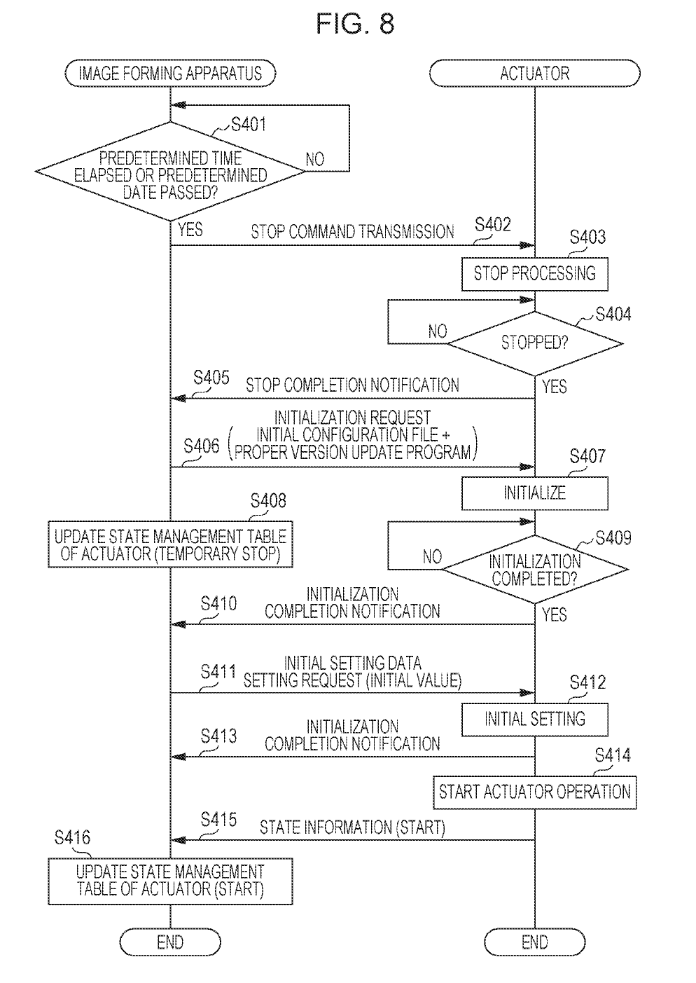

FIG. 8 illustrates a flow of processing when an update program is transmitted to the actuator 30 and the actuator 30 is initialized. In this processing, like the above-described flow, the initializing unit 295 of the image forming apparatus 200 determines whether or not a predetermined time has elapsed, or whether or not a predetermined date has passed (step 401). In other words, the initializing unit 295 determines whether or not a predetermined time has elapsed since previous initialization.

If it is determined that the predetermined time has elapsed in step 401, processing similar to the processing from step 202 to step 205 described above is performed. That is, the initializing unit 295 transmits a stop command to the actuator 30 (step 402), and the actuator 30 performs stop processing of stopping the operation of the actuator 30 itself (step 403). Then, the actuator 30 determines whether or not the stop processing has been completed (step 404). If the actuator 30 determines the completion of the stop processing, the actuator 30 transmits a stop completion notification to the image forming apparatus 200 (step 405).

Then, in this processing, the initializing unit 295 of the image forming apparatus 200 makes a request for initialization to the actuator 30 that has performed the stop processing (step 406). At this time, the initializing unit 295 transmits an update program (program for latest version, or program with countermeasure for weakness) in addition to the information indicative of the request for initialization, to the actuator 30.

In response to the request, the actuator 30 performs initialization processing (step 407). To be specific, the actuator 30 is initialized by the actuator 30 installing the transmitted update program in the actuator 30 itself. Then the processing from step 408 to step 416 is performed. The processing from step 408 to step 416 is similar to the processing from step 208 to step 216 described above, and therefore the description is omitted here.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus, comprising:
an image forming section that forms an image on a recording material;
an acquiring section that acquires information from a plurality of devices that are disposed in a room and acquire information on the room;
a processing section that processes the information acquired by the acquiring section, and generates information that is used by an external device; and
an initializing section that initializes the plurality of devices disposed in the room.

2. The image forming apparatus according to claim 1,
wherein the initializing section sequentially initializes the plurality of devices disposed in the room.

3. The image forming apparatus according to claim 2,
wherein the initializing section sequentially initializes the plurality of devices so that a former device that is initialized first and a later device that is initialized subsequently to the former device have a predetermined positional relationship.

4. The image forming apparatus according to claim 3,
wherein the initializing section sequentially initializes the plurality of devices so that a distance between the former device that is initialized first and the later device that is initialized subsequently to the former device is larger than a predetermined distance.

5. The image forming apparatus according to claim 1,
wherein the initializing section holds information that is stored in each of the plurality of devices before the initializing section initializes the device, and transmits the information to the device after the initializing section ends the initialization of the device.

6. The image forming apparatus according to claim 1,
wherein the initializing section stops each of the plurality of devices when the initializing section initializes the device.

7. The image forming apparatus according to claim 1, further comprising:
a transmitting section that transmits information from each of the plurality of devices to the external device,
wherein, for a device which is being initialized by the initializing section and whose output of information is intermitted, the transmitting section transmits information alternative to the information from the device in the intermission, to the external device.

8. The image forming apparatus according to claim 7,
wherein, for the device which is being initialized by the initializing section and whose output of the information is intermitted, the transmitting section transmits information that is output by the device before the initialization is started, to the external device.

9. The image forming apparatus according to claim 7,
wherein, for a device during initialization that is the device which is being initialized by the initializing section and whose output of the information is intermitted, the transmitting section transmits information that is output from another device having a predetermined positional relationship with respect to the device during the initialization, to the external device.

10. An image forming apparatus, comprising:
an image forming section that forms an image on a recording material;
an acquiring section that acquires information from a plurality of devices that are disposed in a room and acquire information on the room;
a processing section that processes the information acquired by the acquiring section, and generates information that is used by an external device; and
a setting section that performs setting of the plurality of devices disposed in the room.

11. The image forming apparatus according to claim 10,
wherein the setting section performs setting of matching versions of programs that are stored in the plurality of respective devices.

12. The image forming apparatus according to claim 10,
wherein the setting section sets passwords for the plurality of respective devices disposed in the room.

13. The image forming apparatus according to claim 10,
wherein the setting section sequentially performs the setting of the plurality of devices disposed in the room.

14. The image forming apparatus according to claim 10,
wherein the setting section holds information that is stored in each of the plurality of devices before the setting section performs the setting of the device, and transmits the information to the device after the setting section ends the setting of the device.

15. The image forming apparatus according to claim 10,
wherein the setting section stops each of the plurality of devices when the setting section performs the setting of the device.

16. The image forming apparatus according to claim 10, further comprising:
a transmitting section that transmits information from each of the plurality of devices to the external device,
wherein, for a device on which setting is being performed by the setting section and whose output of information is intermitted, the transmitting section transmits information alternative to the information from the device in the intermission, to the external device.

17. An information processing system, comprising:
a plurality of devices that are disposed in a room and acquire information on the room; and
an information processing apparatus that is disposed in the room, processes the information from the plurality of devices disposed in the room and generates information that is used by an external device, and initializes the plurality of devices disposed in the room.
